(19) United States
(12) Patent Application Publication
(10) Pub. No.: US 2014/0052417 A1
(43) Pub. Date: Feb. 20, 2014

(54) Residential Ductwork System

(71) Applicant: Ductmate Industries, Inc., East Monongahela, PA (US)

(72) Inventors: Douglas G. Gudenburr, Finleyville, PA (US); Alvin L. Jefferson, Pittsburgh, PA (US); Branden Butella, McKeesport, PA (US); David Agee, Finleyville, PA (US); David E. Overdorff, II, Ruffs Dale, PA (US); Duane Fetko, Masontown, PA (US)

(73) Assignee: Ductmate Industries, Inc., East Monongahela, PA (US)

(21) Appl. No.: 13/966,365

(22) Filed: Aug. 14, 2013

Related U.S. Application Data
(60) Provisional application No. 61/683,059, filed on Aug. 14, 2012.
(60) Provisional application No. 61/682,856, filed on Aug. 14, 2012.
(60) Provisional application No. 61/682,938, filed on Aug. 14, 2012.
(60) Provisional application No. 61/682,956, filed on Aug. 14, 2012.

(51) Int. Cl. G06F 17/50; F24F 13/02

(52) U.S. Cl. CPC G06F 17/5004; F24F 13/0272
USPC 703/1; 29/897.3

(57) ABSTRACT

A high efficiency HVAC duct system for residential ductwork that is useable for multiple residential houses and is sealed from the manufacturing process.

### CROSS-REFERENCE TO RELATED APPLICATIONS

This application claims the benefit of U.S. Provisional Application Nos. 61/683,059, 61/682,938, 61/682,856, and 61/682,956, all filed Aug. 14, 2012 and all of which are hereby incorporated by reference in their entireties.

### STATEMENT REGARDING FEDERALLY SPONSORED RESEARCH OR DEVELOPMENT

Not Applicable

### INCORPORATION-BY-REFERENCE OF MATERIALS SUBMITTED ON A COMPACT DISK

Not Applicable

### BACKGROUND

In conveying heated or cooled air from a furnace or an air conditioner, the air is usually conducted to a rectangular cross-section main duct and thereafter through branch ducts that extend from the main duct. In recent years, these branch ducts have been formed from sealed circular cross-section sheet metal pipe. These branch ducts then carry the conditioned air to registers that open into rooms in the building to permit circulation of the conditioned air within the rooms.

The transition of air from the main duct to the branch duct has not been very efficient because the branch ducts usually extend at right angles to the main duct causing turbulence in the air as it transfers. Further, the type of fittings used previously has required extensive sealing to prevent leakage of air through the joints. Newer building codes now require that there be minimal leakage in the heating and air conditioning systems.

Traditional systems and methods of installation require the installers to lay out all of the ductwork and fittings and paint them so that they are all sealed. Additionally, there is no standard installation and the configuration of the ductwork all depends on the installer for residential systems.

In commercial systems the ductwork is all manufactured for each specific building. The reason is because the cost of the building allows for custom manufacturing and designing of HVAC systems.

The current residential structure does not include any designed HVAC systems. Large residential builders, such as Ryan® and Moranda® homes, often use a general floor plan for different models of homes. The floor plan and basic design will remain the same, but the exterior aesthetics can be altered, as well as some of the interior features. However, the basic home plan and rooms remain the same and those plans are used to build many homes.

The present invention increases both the efficiency of the flow of air through the system and the ease of assembly of the system, as will be seen as the description proceeds in conjunction with the attached drawings and the appended claims. The system can also reduce noise and vibration.

### BRIEF SUMMARY OF THE INVENTION

The present invention is a predesigned sealed system for residential homes. The entire system is sealed when it leaves the manufacturer and the installer does not have to seal any portions of the systems. Additionally, the system can be designed to increase air flow, reduce energy consumption, reduce installation time, reduce vibration and reduce noise.

The present invention provides for a method for creating a HVAC ductwork system for a residential house. A residential house plan that is to be used to build more than one residential house is obtained and reviewed. A HVAC design engineer or architect designs a HVAC ductwork system to fit that house plan, wherein the system optimizes the air flow throughout the house and can be reused in more than one residential home built from the residential house plan. The designer's or architect's design is reduced to a system plan that can be delivered to a home builder and then is delivered to the home builder. The builder or HVAC contractor or installer buys or obtains manufactured ductwork called for in the plan and then installs the HVAC system in the residential house according to the system plan. The HVAC ductwork system can be a completely sealed system or self sealing as supplied from the manufacture so that the installer does not have to seal any items. The system can also increase the air flow and efficiency over non-sealed systems by 5, 10, or 20%. Because of the efficiency of the system, it is likely that flow rate of air to all of the rooms is within 10% of each other. The HVAC system allows for a reduction in the installation time of at least 10 minutes over traditional HVAC systems. Additionally, it will allow for the reduction of 1 man hour day.

This invention also provides for a method for installing a sealed ductwork system by providing: (1) a main duct line that is sealed during manufacturing in order to reduce air leakage and that will meet code requirements without the installer having to apply sealing material to the duct line; (2) fittings that are sealed during manufacturing in order to reduce air leakage and that will meet code requirements without the installer having to apply sealing material to the fittings; and (3) branch ducts that are sealed during manufacturing in order to reduce air leakage and that will meet code requirements without the installer having to apply sealing material to the branch ducts. The above described system is then installed without the installer having to apply any sealant. The method reduces installation time for an installer by at least 10 minutes and will typically reduce one man hour day (the amount of work produced from one worker in one day). The method also allows for reducing the vibration and noise over a traditional HVAC system.

### BRIEF DESCRIPTION OF THE DRAWINGS

FIG. 1 is a perspective view of the high efficiency fitting of the present invention.

FIG. 2 is a perspective view of a boot.

FIG. 3 is a perspective view of sealed duct.

FIG. 4 is perspective view of a sealed duct system within a house.

FIGS. 5A and 5B are sectional views of a sealed longitudinal seam.

FIG. 6A is a perspective view of circular duct having sealant on the transverse joint male end. FIG. 6B is a section view of 6A along lines 6B.

FIG. 7A is a perspective view of circular duct having sealant on the transverse joint female end. FIG. 7B is a section view of 7A along lines 7B.

FIG. 8 shows a high efficiency fitting attached to a main duct that is attached to the joists in a structure in a side elevation view.

### DETAILED DESCRIPTION

Large residential home builders have basic building design models for a variety of homes. The homes have the same basic structure and configuration, but sometimes contain modifications in appearance and material selection such as flooring countertops, doors, etc. However, the basic layout and configuration remain the same to reduce the cost and efficiency in which the home is built.

The HVAC is installed after the homes are built. The same home design could end up with multiple, different, HVAC ductwork configurations and it will depend on the particular installer. This can lead to increases in time in installation, as well as inefficient air flow which increases energy consumption and cost for home owners. The installer in current methods often has to lay out parts and seal all of the parts prior to installation with a mastic type application. This is typically at least an 8 hour day for one installer.

In addition, this type of installation can often lead to inefficient air flow. It is common for people owning a home to complain about the air flow being less or the temperature in one room being different from the other rooms in the house. This can be created by inefficient HVAC ductwork system design.

Furthermore, because of the materials used and the design, home owners often complain about the noise and vibration created by the HVAC system.

The present invention solves all of the above prior art issues.

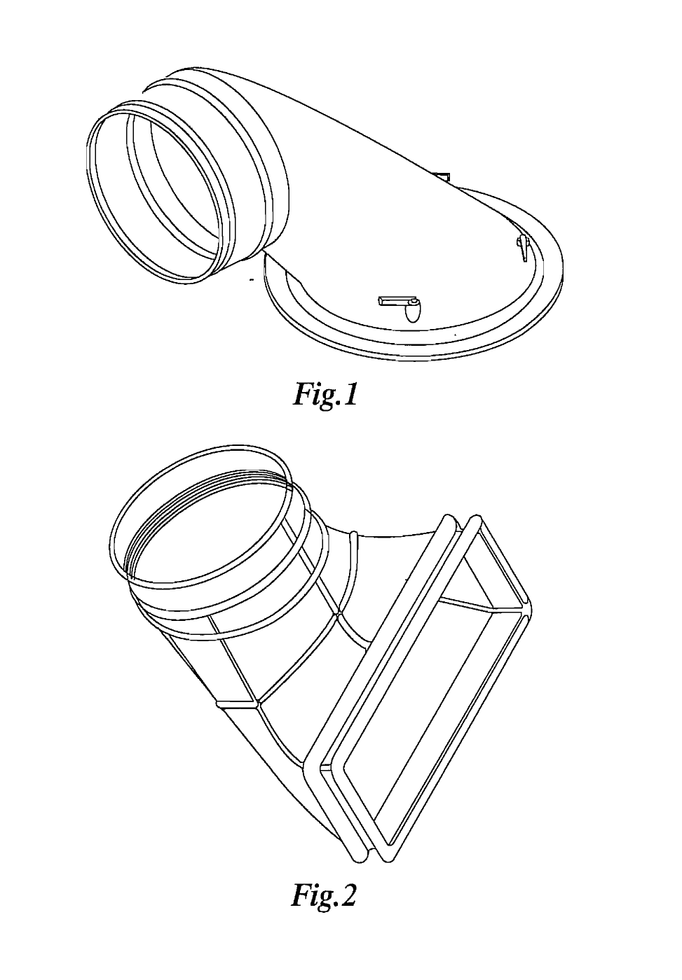

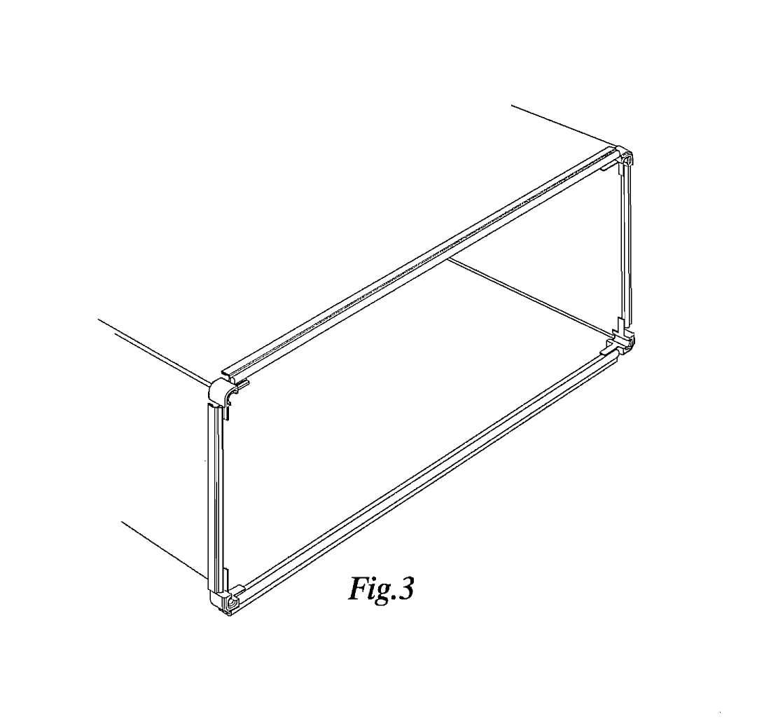

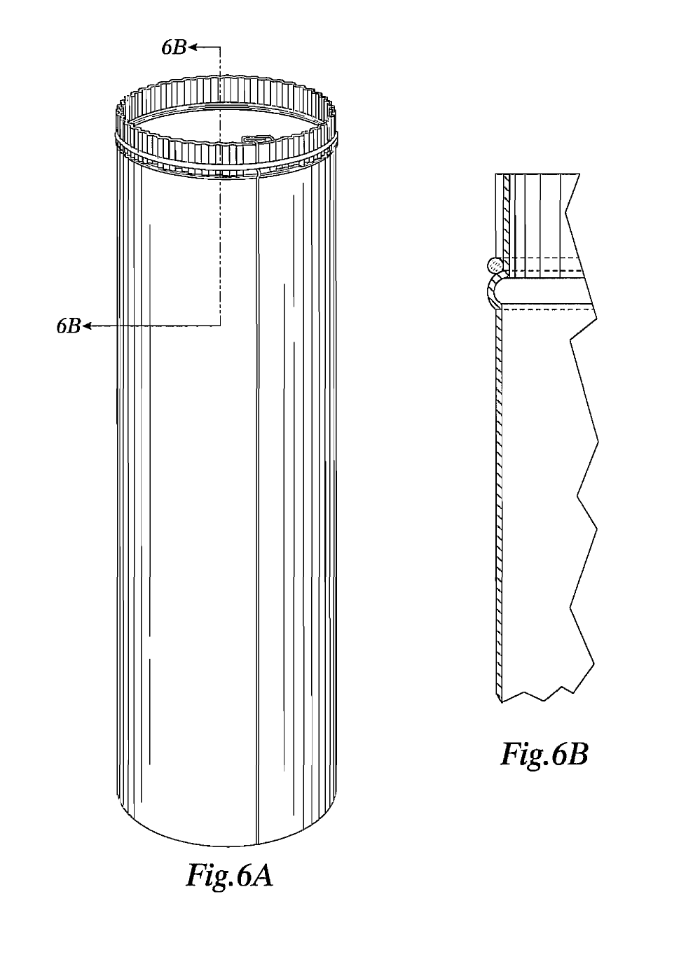

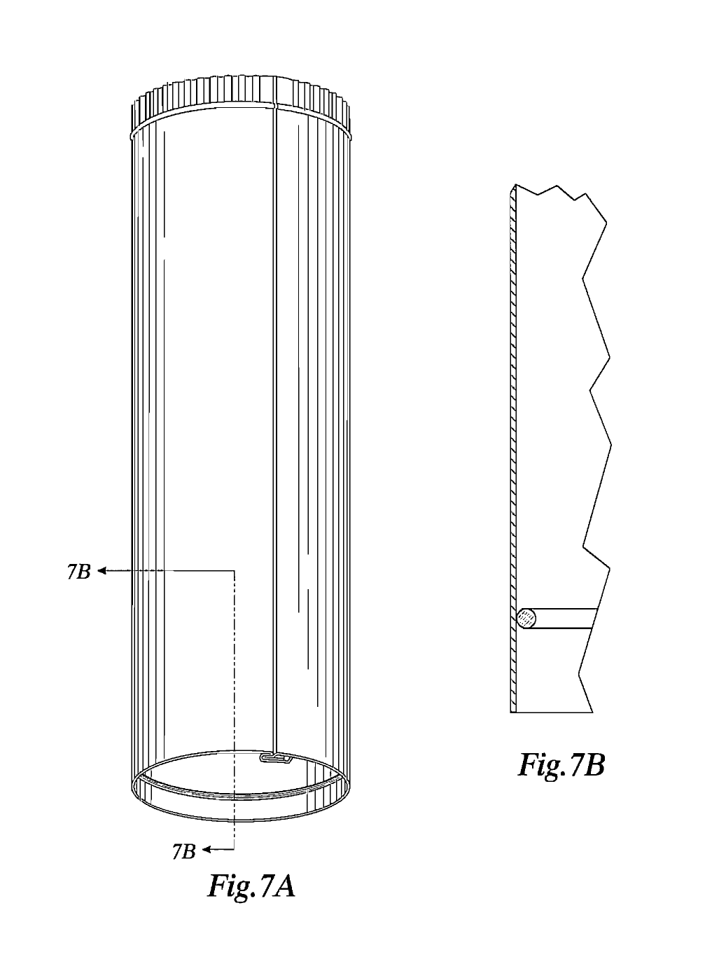

A HVAC plan will be created and especially adapted for the particular home plan. A HVAC designer or architect will review the house and design a plan for that particular housing plan. The plan may take into account savings on air flow efficiency, noise reduction and vibrations. The design can use pre-sealed technology designed as shown in the FIGS. 1-8. The system can also use more aerodynamic ductwork from manufacturers that can increase the air flow over traditional sheet metal ducts, which is shown in FIGS. 1, 2, 4 and 8. Additionally, the duct system can have parts that are made of composite materials such as plastic, rubber or elastomeric polymers. The duct system may also use vibration reducers. Some of the parts that can be made from plastic, rubber, or elastomeric polymers are shown in FIG. 1 and FIG. 2. All of the above features will decrease noise and vibration from the HVAC system, both individually and in combination.

In order to provide a complete sealed system, the following U.S. patents and U.S. patent applications and their teachings of how to make and use the individual sealed parts are hereby incorporated by reference in there entireties:

1) U.S. Pat. No. 7,478,467 for “Self Locking Sheet Metal Duct With A Sealant And Method For Manufacturing The Duct With A Sealant And Installing The Duct With A Sealant” to Gudenburr et al.;

2) U.S. Pat. No. 7,992,904 for “Sealing Mechanism For Ductwork” to Bloom et al.;

3) U.S. Pat. No. 8,429,803 for “Dual Purpose Dimple for HVAC Circular Ductwork” to Coughenour et. al.;

4) U.S. application Ser. No. 13/095,253 for “ HVAC Round Pipe Sealed Fittings,” filed Apr. 27, 2011 by Duane Fetko;

5) U.S. Application No. 61/682,938 for “High Efficiency Take off Fitting,” filed Aug.14, 2012 by Alvin L. Jefferson et al.;

6) U.S. Application No. 61/682,956 for “Rectangular Sheet Metal Sealed Duct,” filed Aug. 14, 2012 by Douglas G. Gudenburr et al.;

7) U.S. Application No. 61/682,856 for “Flexible Register Boot for Heated and Cooled Air,” filed Aug. 14, 2012 by Alvin L. Jefferson et al.;

8) U.S. application Ser. No. 13/965,423 for “High Efficiency Take-Off Fitting,” filed Aug. 13, 2013 by Alvin L. Jefferson et al.;

9) U.S. application Ser. No. 13/965,755 for “Rectangular Sheet Metal Sealed Duct,” filed Aug. 13, 2013 by Douglas G. Gudenburr et al.; and

10) U.S. application Ser. No. 13/965,304 for “Flexible Register Boot for Heated and Cooled Air,” filed Aug. 13, 2013 by Alvin L. Jefferson et al.

From the above teaching, a person of ordinary skill in the art would be able to make and use the system claimed, described and shown in the drawings. It should be noted that some or all of the above devices can be used individually or in combination to create the sealed system.

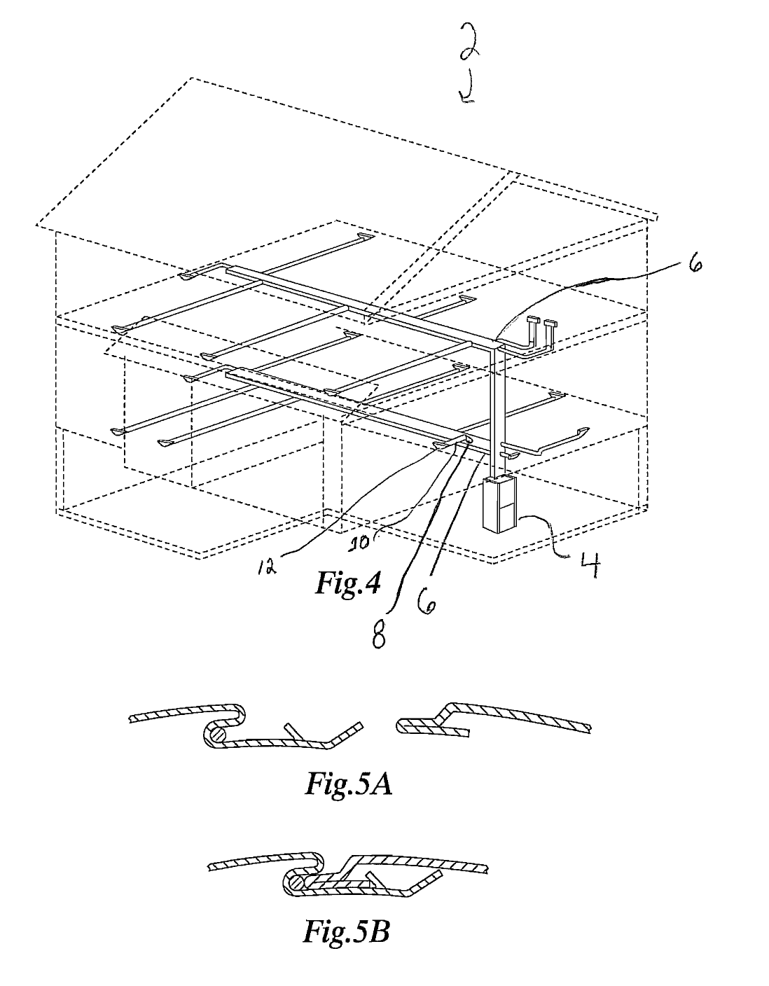

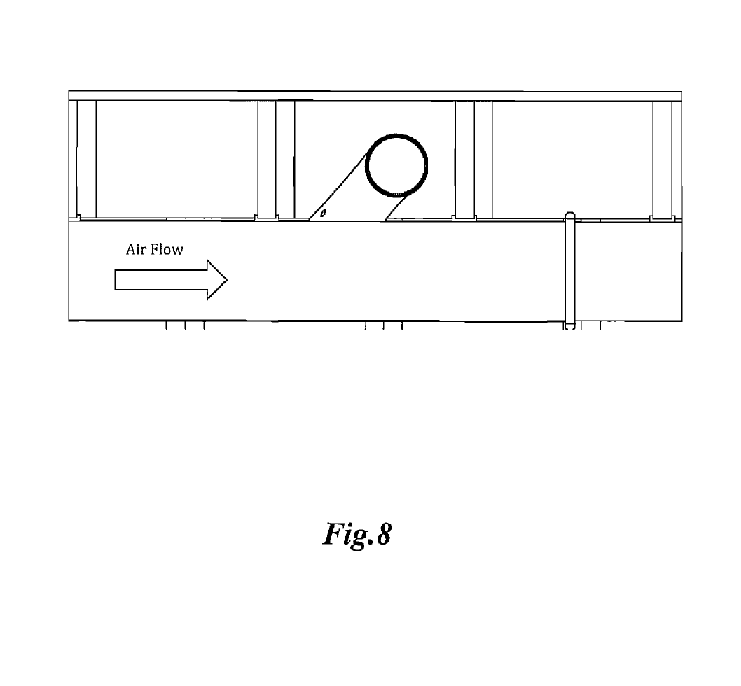

A structure 2 requiring HVAC system is shown in FIG. 4. A source of condition air 4 is typically installed in the lowest level of the structure 2. Main trunk ducts 6 run along the width of the structure typically perpendicular to the joists. A high efficiency take-off 8 (as shown in FIGS. 1 and 8) diverts the air flow from the trunk duct to the branch duct 10. The branch duct typically is round snap lock duct. The round duct then connects to a register boot 12 (as shown in FIG. 2). The register boot 12 then houses the register. Through the structure the air flow can vary because of the distance and turns from the source of conditioned air 4. If there is significant leakage, as with traditional ductwork systems, the farther away from the source of conditioned air 4, the less the air flow will be to that register. Because of the leakage and inefficiencies of flow of the prior art systems, it makes it difficult or impossible to balance the flow of air to the rooms. By using an efficient design with a pre-sealed system it becomes possible to create a system where there is less that 10% air flow variance from room to room.

The following tables show the improved air flow through a duct system having a take-off and register boot as shown in FIGS. 1 and 2. The data shown in Table A is air flow through the prior art system having a traditional register and take-off In Table B, the prior art take-off and register were replaced with the take-off and register boot shown in FIGS. 1 and 2.

After the installer designs the system, manufactured HVAC ductwork will be used. By using pre-sealed or self sealing technology, as described, one man hour day can be saved which reduces cost for the contractors and installers. Additionally, because of the increased air flow of the system, the conditioned air source will not need to run as long to obtain desired temperatures and thus will reduce energy consumption and costs.

TABLE A
Prior Art

| Target FPM | | Actual FPM | CFM |
|---|---|---|---|
| 2 × 4 Duct | 360 | 370.8 | 103.0824 |
| 6″ Pipe | 507 | 560 | |
| Trk Duct | | 1214.3 | 1517.875 |

TABLE B
New

| Target FPM | | Actual FPM | CFM |
|---|---|---|---|
| 2 × 4 Duct | 360 | 419.6 | 116.6488 |
| 6″ Pipe | 507 | 608 | 119.32 |
| Trk Duct | | 1153.4 | 1441.75 |

Various changes could be made in the above constructions and method without departing from the scope of the invention as defined in the claims below. It is intended that all matter contained in the above description, as shown in the accompanying drawings, shall be interpreted as illustrative and not limiting.

I claim:

1. A method for creating a HVAC ductwork system for a residential house comprising:
(a) providing a residential house plan that is to be used to build more than one residential house;
(b) designing a HVAC ductwork system to fit that house plan, wherein the system optimizes the air flow throughout the house and can be reused in more than one residential home built from the residential house plan;
(c) reducing the HVAC ductwork system to a plan that can be delivered to a home builder;
(d) providing the plan to the home builder;
(e) providing HVAC products required by the plan; and
(f) installing the HVAC system in the residential house according to the system plan.

2. The method as recited in claim 1 wherein:
(a) the HVAC ductwork system is a completely sealed system; and
(b) providing the HVAC ductwork system that is completely sealed by the manufacturer without the installer having to seal any items.

3. The method of claim 1 wherein the HVAC system increases the air flow efficiency over traditional systems.

4. The method of claim 1 wherein the HVAC system increases the air flow efficiency over traditional systems by at least 5%.

5. The method of claim 1 wherein the HVAC system increases the air flow efficiency over traditional systems by at least 10%.

6. The method of claim 1 wherein the HVAC system increases the air flow efficiency over traditional systems from 1-20%.

7. The method of claim 1 wherein the HVAC system provides air flow to all rooms at a flow rate within a 10% range.

8. The method of claim 1 wherein the HVAC system allows for a reduction in the installation time of at least 10 minutes over traditional HVAC systems.

9. A method for installing a sealed ductwork system:
(a) providing a main duct line that is sealed during manufacturing in order to reduce air leakage and that will meet code requirements without the installer having to apply sealing material to the duct line;
(b) providing fittings that are sealed during manufacturing in order to reduce air leakage and that will meet code requirements without the installer having to apply sealing material to the fittings;
(c) providing branch ducts that are sealed during manufacturing in order to reduce air leakage and that will meet code requirements without the installer having to apply sealing material to the branch ducts; and
(d) installing the main duct line, the fittings and branch ducts to create a sealed ductwork system in which conditioned air travels through that meets code without the installer applying any sealing material to the system.

10. The method of claim 9 wherein the method reduces installation time for an installer by at least 10 minutes.

11. The method as recited in claim 9 wherein the method includes reducing the vibration and noise over a traditional HVAC system by using vibration reducers.

12. The method as recited in claim 9 wherein the method reduces installation time by at least one man day.
